(19) United States
(12) Patent Application Publication
(10) Pub. No.: US 2002/0149716 A1
(43) Pub. Date: Oct. 17, 2002

(54) LC shutter laminated on display panel of display device

(75) Inventors: Gosse Charles DeVries, Eindhoven (NL); Dirk Jan Broer, Eindhoven (NL); Hendrik DeKoning, Eindhoven (NL)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/122,794

(22) Filed: Apr. 12, 2002

(30) Foreign Application Priority Data
Apr. 17, 2001 (EP) 01201395.9

(51) Int. Cl. G02F 1/1333

(52) U.S. Cl. 349/86

(57) ABSTRACT

Picture display device having a display panel with an active part on which pictures are displayed, an LC shutter of a size corresponding to the size of the active part of the display panel being arranged in front of the display panel, electrode means being provided for energizing the LC shutter, wherein the energizing being effected in accordance with the on/off operation of the display device, the LC shutter includes an LC cell, the LC cell comprises an LC-gel which can be switched between a light-transmissive state and an opaque, particularly scattering, state, and the LC shutter is fixed to the surface of the display panel by means of an adhesive. The LC shutter becomes transparent in the case of electric breakdown.

The invention relates to a picture display device having a display panel with an active part on which pictures are displayed, a L(iquid) C(rystal) shutter of a size corresponding to the size of the active part of the display panel being arranged in front of the display panel, electrode means being provided for energizing the LC shutter, the energizing being effected in accordance with the on/off operation of the display device.

The invention further relates to a display apparatus comprising a picture display device.

It is known that picture display devices, like CRTs, Plasma Displays (PDPs), LCDs, when not in operation, have an appearance which is not in harmony with their surroundings. A solution to this problem is described in JP-A 4-132380. In this publication, the outer periphery of an LC cell, which functions as an LC shutter is held by an attaching frame, and the assembly is attached to the front face of the CRT in a television receiver. The LC material in the cell is arranged between electrodes which are turned into a state in which power is supplied in accordance with the on/off operation of the power source of the television receiver. The LC cell is thereby turned to a transparent state at the time of using the television receiver and to a light-absorbing state when the receiver is out of use.

In general, a display device comprises a display window. The image is displayed on the display window. The display window comprises means selectively generating light at areas of the display window. In a CRT, for instance, the image is built line-by-line.

A major problem in display devices is the reflection of ambient light on the display window or at components of the display device such as phosphor elements (in e.g. CRTs and PDPs). Apart from the image generated by the device, the viewer also sees reflections of other light sources, such as lamps and/or the sun shining on the display window. The reflections of such external light sources (i.e. sources outside the display device) reduces the contrast of the image displayed and can even make it invisible especially when bright sunlight shines on the display window. Many solutions have been proposed, ranging from reducing the light intensity in the room, reducing the reflection coefficient of the surfaces of the display window (anti-reflection coatings) and using dark glass for the window (the latter reduces the reflection on the inside of the display window).

However, display panels have a large surface area, and the LC shutters need to have corresponding large surface areas, which makes them, and the required polars, very expensive. Moreover, the use of frames for the assembly makes the devices extra expensive provide an optical coupling between the LC shutter and the display panel which gives rise to unwanted reflections.

In the light of the foregoing, it is an object of the invention to provide an LC shutter which can be made in an inexpensive way.

The above object is solved by a picture display device a display panel with an active part on which pictures are displayed, an LC shutter of a size corresponding to the size of the active part of the display panel being arranged in front of the display panel and electrode means being provided for energizing the LC shutter, the energizing being effected in accordance with the on/off operation of the display device, and is characterized in that the LC shutter includes an LC cell, the LC cell comprising an LC-gel which can be switched between a light-transmissive state and an opaque state.

LC-gel materials are relatively inexpensive to make. Preferably, the LC-gel materials are transparent if no voltage is supplied to the cell, making the shutter fail-safe, and are scattering if a voltage is supplied, with no polars being needed. This will further reduce the costs of the LC shutter, because fail-guard circuitry and polars are not needed.

Preferably, the LC-gel is selected such that the LC shutter can be set either in an open, transparent state or in a closed, light-scattering state.

The LC shutter can be optically coupled to the display panel in various manners, e.g. by laminating it on the panel. In a preferred embodiment, a surface of the LC shutter is fixed to the surface of the display panel by means of an adhesive, whereby the display panel is reinforced as well.

The adhesive may be a cured resin, e.g. an epoxy type material, an acrylic, or meta-acrylic type material, or mixtures thereof, or a gel, but the invention is not limited to these materials.

A simple bonding of the LC shutter to the display panel is warranted if the display panel has a flat surface, as is generally the case in current picture display devices, like PDPs, LCDs and even CRTs (RF types).

The bonding step is further simplified if a seal is arranged between the surface of the display panel and the opposite surface of the LC shutter (which may be a surface of the top-layer or a surface of the substrate) which seal in adjacent the periphery of the top-layer or the surface, so that the space enclosed the display panel, the seal and the top-layer or the substrate can be subsequently filled with a liquid adhesive, preferably of a curable type (by exposure to heat or UV radiation).

According to a further aspect, the LC-gel comprises an oriented LC polymer network, while an LC material having a negative Δε is comprised in cavities of the polymer network. It has been found that a material system of this type provides a shutter which can be switched between a transmitting state and a (milky white) scattering state. An advantage of a material system of this type is that no polar is needed to bring about this effect, so that there is no loss of light and the costs of polars are saved.

Other suitable materials are LC-gel systems which comprise a dye, in particular a pleochroic dye. These materials may be used to optimize the design, for example, for providing a shutter which is neutral gray in its open state and black in its closed state. When such a shutter is used, the CRT display panel will be clear (non-pigmented) instead of pigmented. Suitable dyes provide dichroic effects.

The invention provides a means for hiding a CRT, or other display type like a plasma panel or LCD, by means of a switchable panel (shutter) placed in front of the CRT. This feature may be used to make a TV “invisible” when it is not turned on, while undisturbed TV viewing is possible in the transparent state of the panel. The switchable panel should be transparent in the open state, and the closed state should hide the object. The closed state may therefore be strongly absorbing (e.g. black) or scattering (e.g. milky white, matt). For design reasons, a milky white appearance is preferred. For economic reasons an LC-gel system which enables the LC cell to be set in a closed, light-scattering, state (instead of a light-absorbing state) is preferred, because it does not require polars.

Panels that switch between the transparent state and the scattering state may be based on PDLC (polymer dispersed liquid crystal) the form of Saint-Gobain markets a commercial, but expensive product called Privalite that may in principle be used. It is much cheaper to produce the above material which comprises an LC polymer network having an LC material with a negative Δε in its cavities. The switching time (around 1 ms) is more than fast enough for the envisaged application. And, last but not least, a shutter panel using this material is ‘fail-safe’: in case of electric break-down, the panel becomes transparent, thus allowing TV viewing. In the active scattering state the power consumption is low (<1 W for a large panel with 32″WSRF dimensions).

In order not to disturb the picture in the open state, the shutter panel should preferably be in optical contact with the CRT screen. In this way, the specular reflections of panel-air and CRT screen-air interfaces are avoided.

It is therefore desirable to combine the shutter panel and the real flat (RF) CRT by means of lamination. This provides an inexpensive way of assembling the LC shutter with the display panel. A lamination process is advantageous, in which a cast resin is used as the coupling medium between front panel and tube.

These and further aspects of the invention will be explained in greater detail by way of example and with reference to the accompanying drawings, in which

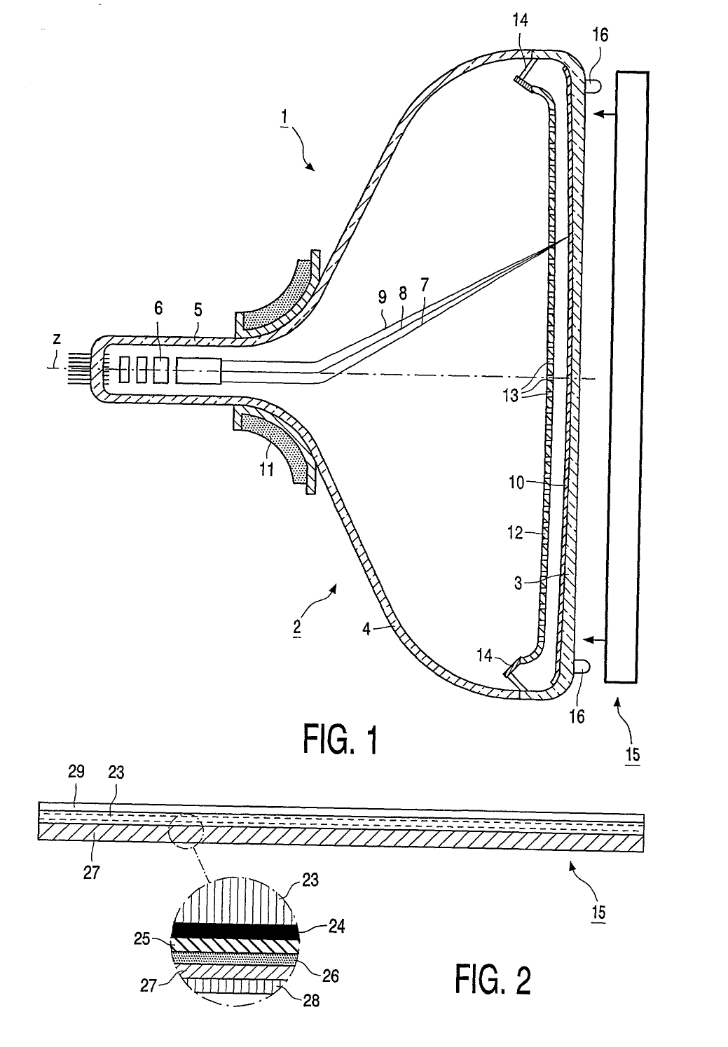

FIG. 1 shows schematically a display device with a LC shutter in a cross-section.

FIG. 2 shows a particular LC shutter in a cross-section;

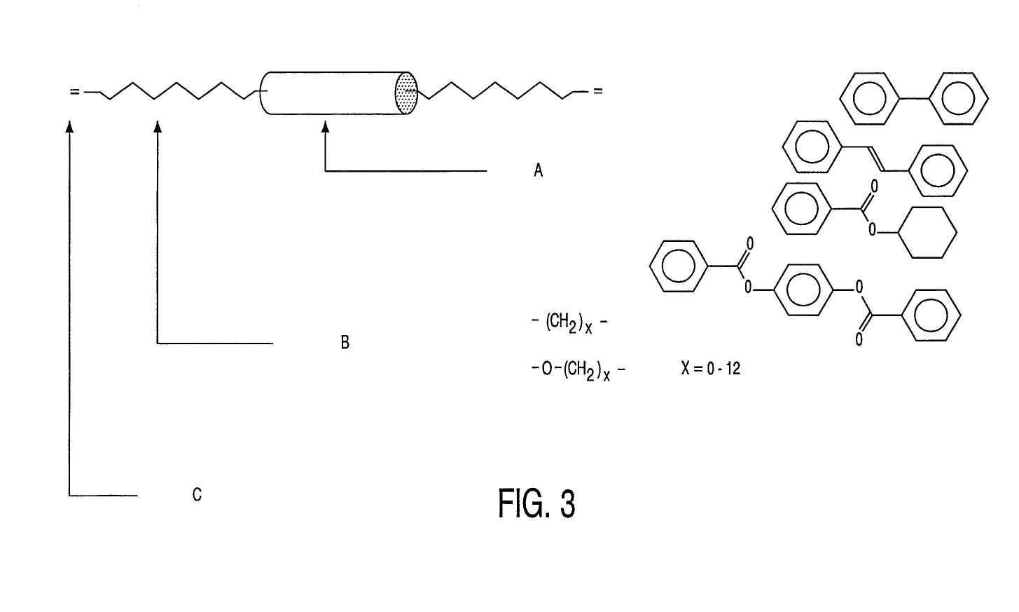

FIG. 3 illustrates some examples of polymerizable liquid crystals usable for the polymer network;

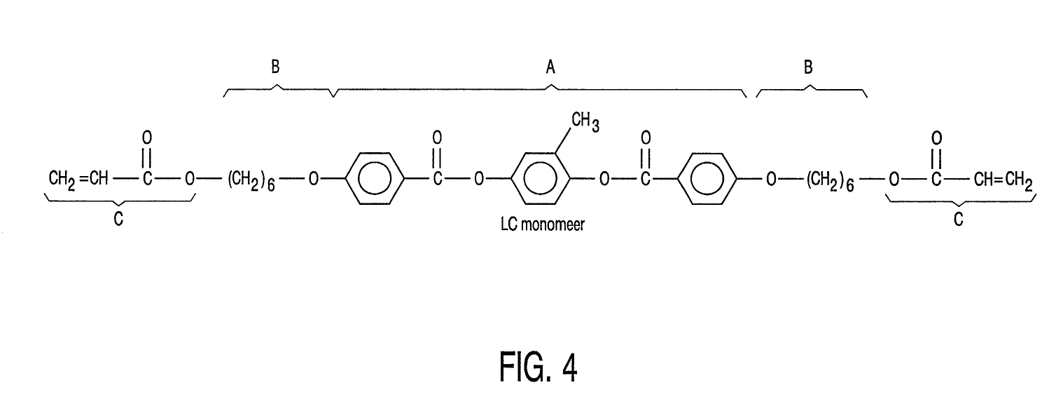

FIG. 4 shows a particular example of a polymerizable liquid crystal;

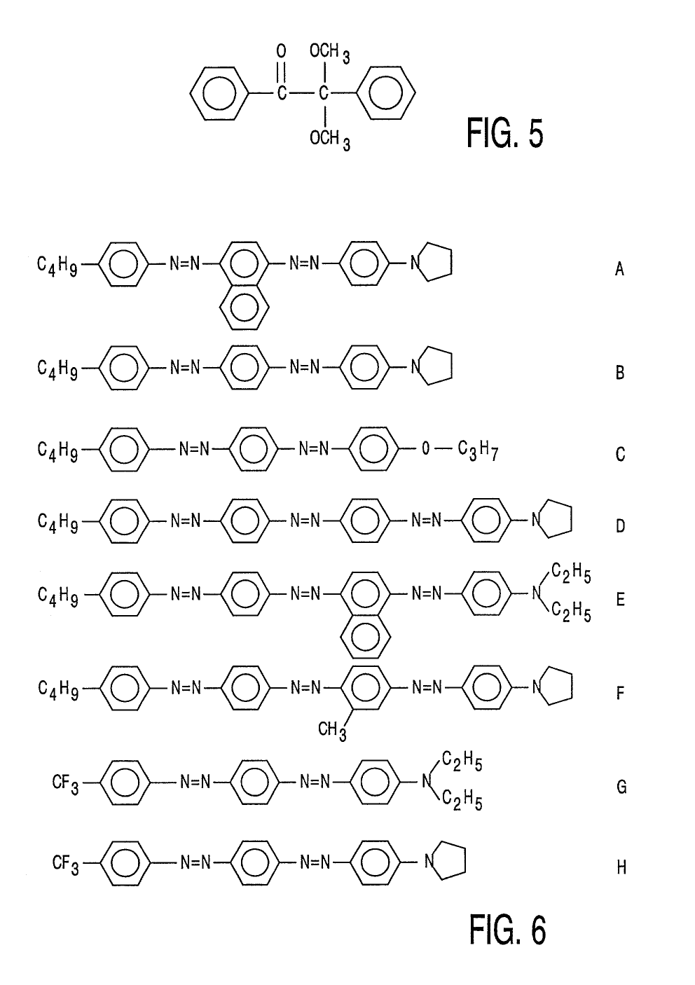

FIG. 5 shows an example of a photoinitiator;

FIG. 6 shows several examples of pleochroic dyes; and

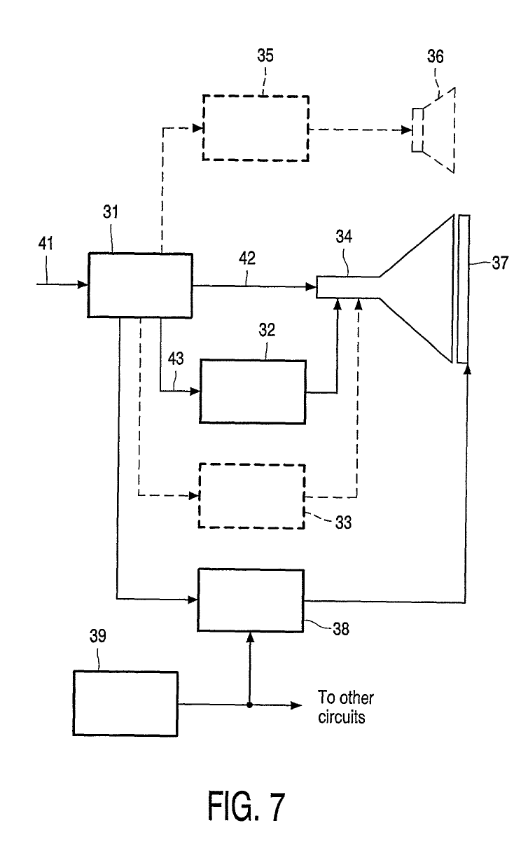

FIG. 7 is a simplified block diagram of a display apparatus.

The Figures, are not drawn to scale. In general, like reference numerals refer to like parts.

A color display device 1 (FIG. 1) includes an evacuated envelope 2 comprising a display window 3, a cone portion 4 and a neck 5. Said neck 5 accommodates an electron gun 6 for generating three electron beams 7, 8 and 9. A display screen 10 is present on the inner side of the display window. Said display screen 10 comprises a phosphor pattern of phosphor elements luminescing in red, green and blue. On their way to the display screen, the electron beams 7, 8 and 9 are deflected across the display screen 10 by means of a deflection unit 11 and pass through a shadow mask 12 which is arranged in front of the display window 3 and comprises a thin plate having apertures 13. The shadow mask is suspended in the display window by way of suspension means 14. The three electron beams converge and pass through the apertures of the shadow mask at a small angle with respect to each other and, consequently, each electron beam impinges on phosphor elements of only one colour. In FIG. 1, the axis (z-axis) of the envelope is also indicated. A shutter means 15 for transmitting and scattering, or absorbing, light is arranged in front of the display window 3.

FIG. 2 illustrates schematically an LC cell 15 for use in the invention. The LC cell comprises a substrate 29, an LC-gel 23 which comprises, in an oriented LC polymer network, an LC material with a negative Δε, transparent electrodes 26 (for instance, made from ITO), a barrier layer 25, a polyamide layer 24, a (e.g. glass) substrate 27 and optionally an anti-reflection layer 28.

An LC cell having an oriented polymer matrix, and an LC material with a negative Δε, but without a (pleochroic) dye in its ‘closed’ state scatters light very efficiently. Thus, such a system seems to be very attractive for “integral” LC shutter applications, which enable the TV screen to be “hidden” or shown.

The content of the oriented polymer matrix is preferably between 5 and 15%. Lower percentages yield relatively large passive switching times, whereas higher percentages yield a relatively high luminance, even in the closed state.

The oriented network is formed by e.g. chain-addition reaction under the influence of UV light of reactive monomer materials such as are shown schematically in FIG. 3. The liquid crystal molecules comprise a stiff central core A, flexible spacers B and polymerizable end groups C. Some examples of the stiff central core and the flexible spacer groups are indicated in FIG. 3. It will be clear that many variations are possible e.g. by addition of alkyl groups to one or more of the rings of the central core part, or by extending the central core part with an extra ring, or by a longer flexible spacer B (i.e. for instance×larger than 12 or a mixture of the groups —(CH₂)— and —O—(CH₂)—, while also the flexible group does not have to be linear but may have side chains. The flexible group at either side of the central core may be different, although it is preferably the same. The polymerizable end groups may be chosen from, for example, meth(acrylates), vinyl ethers, epoxides and thiolenes.

FIG. 4 shows a particular example of a polymerizable liquid crystal.

In order to polymerize the liquid crystals such as shown in, for example, FIGS. 3 and 4, a photoinitiator may be used, e.g. the one as shown in FIG. 5.

Some examples of pleochroic dyes are shown in FIG. 6.

The LC material in the cell may have the following characteristics:

ε_{∥}=4.5

ε⊥=10.2

Δε=−5.7

nₒ=1.486

nₑ=1.650

Δε is negative. Such an LC material may be obtained by mixing several LC components and can be bought from LC material manufacturers.

An “integral” LC shutter means for transmitting/scattering or absorbing light may be made by using conventional methods. To this end, glass plates are covered with (structured) transparent electrodes usually made of ITO. They are coated with thin polyamide or alternative films to establish the liquid crystal orientation. Optionally, the glass plates may be provided with color filters, a black matrix, planarization layers, passivation layers, etc. When active matrix displays are used, the plate may also be provided with some logic. After having undertaken all the coating and lithographic procedures to apply these films, the glass plates are adhered together with an accurately placed adhesive stripe. Previously applied spacers, e.g. glass or plastic spheres or fibers, should maintain the cell gap at a constant value, e.g. 4.5 μm. The adhesive seal is left with some openings that are used to fill the cell. The cell (i.e. the space between two substrates) is filled with a mixture of a polymerizable liquid crystal material as shown in, for example, FIG. 3 or 4, preferably a photoinitiator (as shown, for example, in FIG. 5) and an LC material. After filling, voltages are applied across the electrodes to orient both the molecules of the polymerizable liquid crystal material and of the LC material. The cell is subsequently exposed to UV light to polymerize the polymerizable liquid crystal, forming an oriented LC polymer network. The LC material is comprised within the oriented polymer network.

This system is called an LC-gel. As it comprises a continuous 3D network, it is also called a permanent gel. Another type of LC-gel systems is called physic gel. PDLC type materials belong to this category.

According to an additional feature, the LC cell is capable of presenting a pattern (e.g. a clock) in the opaque (scattering or absorbing) state.

The invention further relates to a display apparatus as defined in claim 11. A simplified block diagram for such a display apparatus is shown in FIG. 7. Input display data 41 is supplied to the videodetector 31. If present, the sound portion of the data is applied to the sound channel 35 which reproduces the sound in speaker 36. The videodetector 31 further applies a display drive signal 42 to the picture display device 34 and synchronizing signals 43 to the addressing means 32. For a CRT, these addressing means 32 comprise deflection circuits for line and frame deflection. For other picture displays, such as LCD or PDP, these addressing means 32 may provide matrix addressing circuits for line and row addressing. If a color signal is present, special color circuit demodulators 33 are present as shown by the broken lines in FIG. 7.

The display apparatus of the invention further comprises a picture display device 34 having a display panel with an active part on which pictures are displayed, an LC shutter 37 of a size corresponding to the size of the active part of the display panel being arranged in front of the display panel, electrode means being provided for energizing the LC shutter 37, the energizing being effected in accordance with to the on/off operation of the display device 34, wherein the LC shutter 37 includes an LC cell, the LC cell comprising an LC-gel which can be switched between a light-transmissive state and an opaque state, and wherein the display apparatus comprises a control means 38 for switching the LC shutter 37, and a power supply 39 for energizing the LC shutter 37. The on/off operation of the display device 34 may be derived from a signal coming from the video detector 31, as shown in FIG. 7. The display apparatus further comprises a power supply 39 for driving the LC shutter 37, preferably via the control means 38. This power supply 39 may also be used to supply power to other circuits.

1. A picture display device having a display panel with an active part on which pictures are displayed, an LC shutter of a size corresponding to the size of the active part of the display panel being arranged in front of the display panel, electrode means being provided for energizing the LC shutter, the energizing being effected in accordance with the on/off operation of the display device, characterized in that the LC shutter includes an LC cell, the LC cell comprising an LC-gel which can be switched between a light-transmissive state and an opaque state.

2. A picture display device as claimed in claim 1, characterized in that a surface of the LC shutter is fixed to the surface of the display panel by means of an adhesive.

3. A picture display device as claimed in claim 1, characterized in that a seal is arranged between the surface of the display panel and the opposite surface of the LC shutter which seal is adjacent, the periphery of the surface of the LC cell, the space enclosed by the display panel, the seal and the surface of the LC cell being filled with an adhesive.

4. A picture display device as claimed in claim 1, characterized in that the LC shutter can be set either in an open, transparent, state, or in a closed, light-scattering, state.

5. A picture display device as claimed in claim 1, characterized in that the LC-gel comprises an oriented LC polymer network, an LC material having a negative Δε being comprised in cavities of the polymer network.

6. A picture display device as claimed in claim 1, characterized in that the LC-gel further comprises a dye.

7. A picture display device as claimed in claim 1, characterized in that the LC shutter closes when it is energized.

8. A picture display device as claimed in claim 7, characterized in that the LC shutter opens (becomes transparent) in the case of electric breakdown.

9. A picture display device as claimed in claim 1, characterized in that, in the opaque state, the LC cell is capable of presenting a pattern.

10. A picture display device as claimed in claim 6, characterized in that the LC cell can be switched between a neutral gray, light-transmissive, state and a black, light-absorbing, state.

11. A display apparatus comprising a picture display device having a display panel with an active part on which pictures are displayed, an LC shutter of a size corresponding to the size of the active part of the display panel being arranged in front of the display panel, electrode means being provided for energizing the LC shutter, the energizing being effected in accordance with the on/off operation of the display device, wherein the LC shutter includes an LC cell, the LC cell comprising an LC-gel which can be switched between a light-transmissive state and an opaque state, and wherein the display apparatus comprises a control means for switching the LC shutter, and a power supply for energizing the LC shutter.
